(19) United States
(12) Patent Application Publication
(10) Pub. No.: US 2015/0136708 A1
(43) Pub. Date: May 21, 2015

(54) DISSOLVED GAS FLOTATION APPARATUS

(71) Applicant: DOOSAN ENPURE LIMITED, Birmingham (GB)

(72) Inventors: Tony Amato, Bridgnorth Shropshire (GB); David Michael Brown, Stourbridge West Midlands (GB)

(21) Appl. No.: 14/401,349

(22) PCT Filed: May 17, 2013
(86) PCT No.: PCT/GB2013/051287

§ 371 Date: Nov. 14, 2014

(30) Foreign Application Priority Data
May 18, 2012 (GB) 1208773.0

(51) Int. Cl. B03D 1/14

(52) U.S. Cl. CPC B03D 1/1431
USPC 210/703; 261/123; 29/428

(57) ABSTRACT

A dissolved gas flotation apparatus (10) comprises: —a flotation tank (18); —one or more pressure reduction nozzles (28) arranged to discharge into the flotation tank (18); —an underflow exit baffle (19) defining the upper part of an exit channel (70) from the flotation tank (18); and —a plurality of flow-contacting members (44) arranged within the flotation tank exit channel. The flow-contacting members (44) may include one or more of vanes; bubble-forming members; bubble-capturing members; bubble-coalescing members; turbulence-introducing members; flow-redirecting members; pressure-increasing or pressure-decreasing members; members which introduce a pressure difference in the flow; and velocity-increasing or velocity-decreasing members.

The present invention relates to a dissolved gas flotation apparatus, to a method of manufacturing the apparatus and to methods of use of the apparatus.

Dissolved gas flotation (also referred to as DAF, an abbreviation for “dissolved air flotation”) is a water treatment process. In DAF, water is clarified by the removal of suspended matter such as oil or solids. DAF is widely used in treating the industrial wastewater effluents from oil refineries, petrochemical and chemical plants, natural gas processing plants and similar industrial facilities. A very similar process known as induced gas flotation is also used for wastewater treatment. Froth flotation is commonly used in the processing of mineral ores.

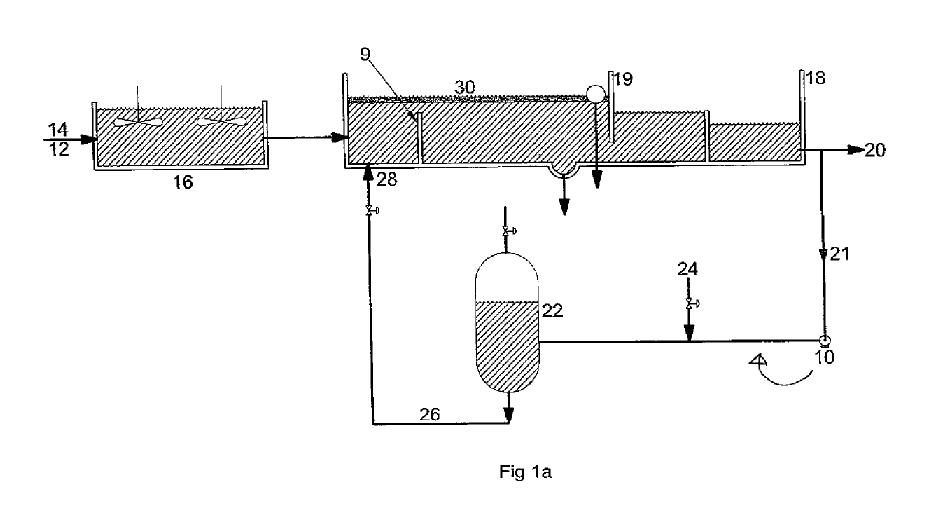

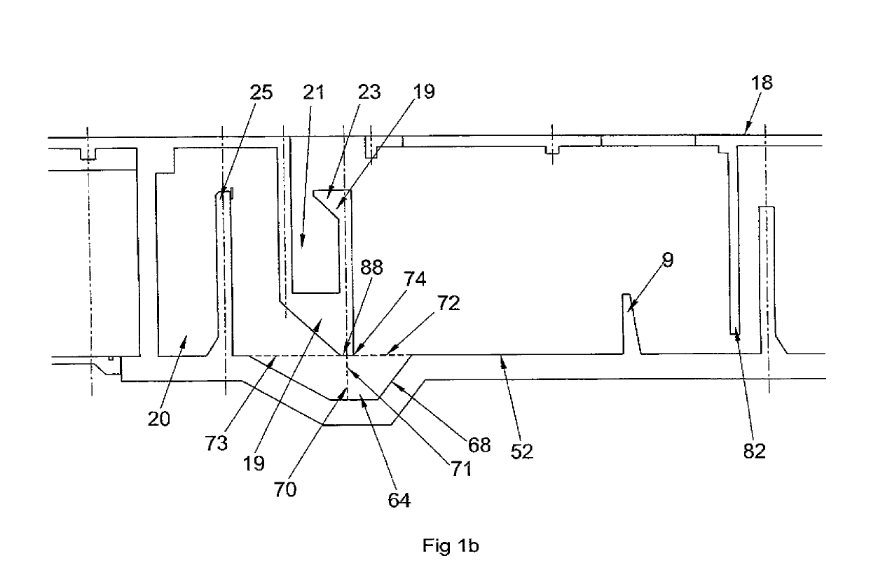

A typical DAF apparatus 10 is shown in FIG. 1a. Feed water 12 is introduced to the apparatus at the upstream end (left), where it may be dosed with a coagulant 14 (e.g. ferric chloride or aluminium sulfate) via an inline mixer or a flash mixer comprising a single mixer and small tank (not shown). The water is passed to a chemical mix tank 16 to flocculate the coagulated suspended matter and then to a flotation tank (also referred to as a “cell”) 18 (of depth typically at least 3-4 m) at atmospheric pressure. The flotation tank 18 includes an underflow exit baffle 19 at the downstream end (right), allowing effluent water 20 to be withdrawn from the flotation tank 18. A portion of the effluent water 20 leaving the flotation tank 18 is recycled. The recycled water 21 is pumped into a saturator vessel (small pressure vessel) 22 into which gas e.g. compressed air 24 is also introduced so that the water is saturated with gas. The gas-saturated water stream 26 is passed through a pressure reduction nozzle 28 into the flotation tank 18. On passing through the pressure reduction nozzle 28, the gas is released from solution in the form of micro-bubbles which adhere to the suspended matter. The micro-bubbles rise to the surface of the water, carrying the suspended matter with them. The suspended matter forms a froth 30 which may then be removed using a skimming device. A suitable DAF pressure reduction nozzle 28 is described in WO2011/042494 of the current applicant.

The flotation tank 18 is shown in more detail in FIG. 1b (note that in this and subsequent figures the upstream end is at the right and the downstream end at the left).

The flotation tank 18 has a base 52 and walls (not shown). An inlet underflow baffle 82 is provided at the upstream end. The pressure reduction nozzles (not shown) are close to the base 52 of the tank 18 just downstream of the inlet underflow baffle 82. An inclined baffle 9 is provided in the base 52 of the tank 18 downstream of the pressure reduction nozzles in order to direct flow. The tank base 52 has a trough 64 at its downstream end, the trough 64 having a sloping upstream wall 68.

The underflow baffle 19 is U-shaped in cross-section, and its hollow interior forms a sludge hopper 21. A shelf-like beach 23 extends partway over the sludge hopper 21 on its upstream side. An outlet weir 25 is provided downstream of the underflow baffle 19. The outlet weir is fixed during commissioning to control the level of water and sludge on the beach 23.

The lower wall 88 of the underflow baffle is horizontally level with the main part of the base 52 of the DAF tank. This lower wall 88 and the trough 64 in the base 52 together define a tank exit channel 70. The tank exit channel has a minimum cross-sectional area A (relative to the flow direction, in a vertical plane) at a part 71 of height a directly below the underflow baffle lower wall 88. The area A is important in setting the initial velocity. The tank exit channel 70 has an upstream part 72 vertically above the trough upstream sloping wall 68 and horizontally upstream of the upstream lower edge 74 of the underflow baffle 19, the upstream part 72 being of length (along the flow direction, in a horizontal plane) greater than a and up to 2a. The tank exit channel 70 has a downstream part 73 horizontally downstream of the lower wall 88 of the underflow baffle 19, the downstream part 73 similarly being of length (along the flow direction, in a horizontal plane) greater than a and up to 2a.

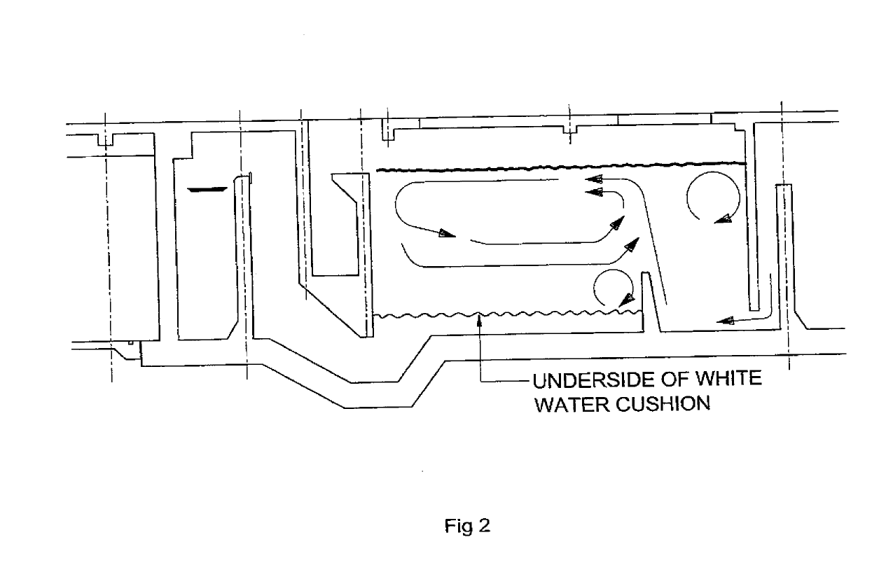

It has recently been appreciated (Amato & Wicks, 2007, 2009-1 and 2009-2) that for efficient operation sufficient air needs to be injected into the DAF apparatus not only for flotation to occur but also to maintain stability of the internal flow paths within the apparatus. These flow paths form a white water “cushion” with a lower front (the “white water level”, WWL) above the underflow baffle. Recirculation occurs within the white water cushion (FIG. 2).

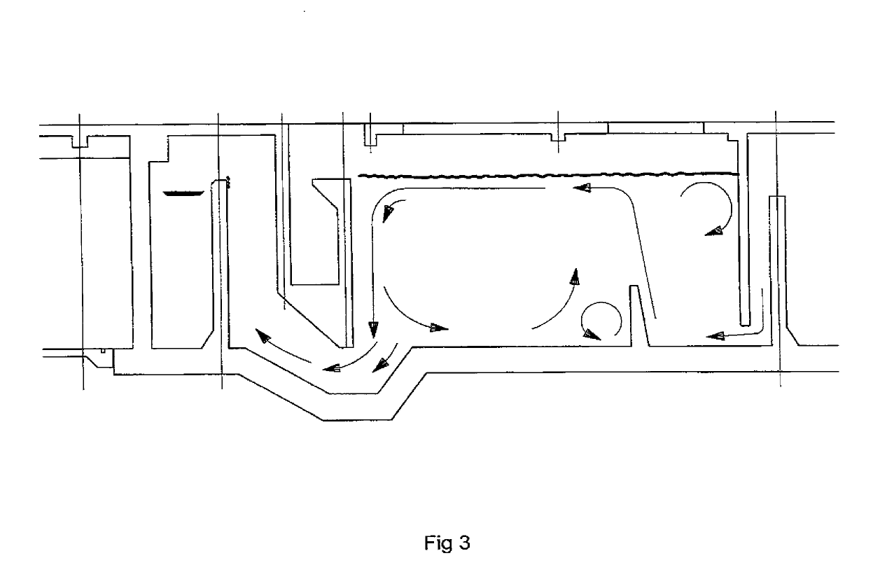

Stable internal flow paths mean that “short circuiting” is avoided, allowing suspended particles to be retained for longer to increase the chance of particle capture. If white water is lost from the DAF tank via the underflow baffle the recirculation may be stopped (FIG. 3) and stability lost. Loss of white water from the DAF tank occurs particularly at high flow rates and/or low water temperatures, and in saline water.

Loss of white water from the DAF tank via the underflow baffle is undesirable. Suspended particles may exit the tank rather than rising to the surface. Bubbles may also exit the tank. Such bubbles will affect in-line turbidity meters to give a false reading, increasing the need for off-line laboratory turbidity measurements (which are not affected in this way). Generally smaller bubbles due to their small size and greater relative surface area interfere to a greater extent than larger bubbles with the measurement. Bubble traps (de-bubblers) do not reliably prevent this problem, particularly for small bubbles. In addition, bubbles can act as particles in the downstream filter unit to increase the apparent load on the filter.

Loss of white water from the DAF tank can be addressed by using a deeper DAF tank. However, tanks with a depth of over 4 m are not well accepted in the marketplace because of the costs of construction.

WO97/20775 discloses a DAF tank using pipes or plates to promote bubble coalescence. A similar arrangement using subnatant tubes is discussed in Amato and Wicks 2009-2. However, the inventors have observed that such tanks are generally 4 to 4.5 m in depth, with only a small depth saving of about 300 mm, and involve added cost and complexity. Maintenance of such tanks would be difficult: for example material would need to be cleaned from under the plates of the tank of WO97/20775.

In a first aspect, the present invention provides a dissolved gas flotation apparatus comprising:
a flotation tank;
one or more pressure reduction nozzles arranged to discharge into the flotation tank;
an underflow exit baffle defining the upper part of an exit channel from the flotation tank; and
a plurality of flow-contacting members arranged within the flotation tank exit channel.

Preferably, the flow-contacting members include one or more of:
vanes;
bubble-forming members;
bubble-capturing members;
bubble-coalescing members;
turbulence-introducing members;
flow-redirecting members;
pressure-increasing or pressure-decreasing members;
members which introduce a pressure difference in the flow; and velocity-increasing or velocity-decreasing members.

More preferably, the flow-contacting members are vanes. The vanes are also referred to herein as “wings”.

Without wishing to be bound by this theory, the inventors believe that the flow-contacting members promote bubble formation, capture and/or coalescence from the gas-supersaturated stream at the tank exit channel. The flow-contacting members increase the available contact surface.

Preferably, the dissolved gas is air. However, other gases may be used. For example, natural gas (essentially methane) may be used in the oil industry as the absence of oxygen helps to minimise explosion risk.

It is preferred that all components of the apparatus be acceptable for use with waters intended for potable supply. However, in practice DAF-treated water (e.g. sea water) may require further treatment (e.g. via a membrane process) to produce potable water. Where this is the case, it is not necessary for the components of the apparatus to be acceptable for use with waters intended for potable supply.

Preferably, the vanes are substantially parallel to one another, and more preferably the vanes have their principal axes substantially horizontal. However, the vanes may be differently arranged, for example they may have their principal axes substantially vertical. The vanes preferably have their principal axes arranged substantially perpendicular to the flow direction.

Preferably, the vanes are vertically spaced from one another. They may also be horizontally spaced from one another.

Preferably, the vanes are cylindrical with a substantially constant cross-section. “Cylinder” in this context refers to a solid figure of uniform cross-section generated by a straight line remaining parallel to a fixed axis and moving round a closed curve. The cylinder may have a transverse cross-section of any shape (not necessarily circular). The term “cross-section” used herein in connection with the vanes refers to a transverse cross-section). The vanes are generally rod-like i.e. with length greater than their cross-sectional dimensions.

Suitably, the vanes have a minimum transverse cross-sectional dimension of 2 mm or more and/or a maximum transverse cross-sectional dimension of 300 mm or less. Typically the cross-sectional area will be up to 0.02 m², for example around 0.005 m².

Suitably, the vanes have lengths of 8 to 12 m, for example lengths up to 10 m.

Preferably, some or all of the vanes have edges. Edges, and in particular sharp edges (i.e. edges which form an angle of 90° or less, preferably an acute angle, in cross-section), assist in bubble capture. Vanes with a triangular cross-section are especially preferred. Other preferred vane cross-sections include quadrilateral (e.g. diamond) cross-sections or star-shaped cross-sections. An alternative possibility is for the vane to be in the form of a plate, preferably a non-planar plate e.g. with V-shaped or Z-shaped cross-section (although a planar plate is also possible). Vanes with a circular or generally curved cross-section are not preferred. It is undesirable for the vane shape to be very complex, as this may lead to build-up of solid matter. Such build-up presents maintenance problems, and in large quantities may lead to distortion or bowing of the vanes.

Preferably, a sharp edge of a vane is positioned such that in use it is directed upstream into the oncoming flow.

It is desirable to use the vanes to produce pressure differences in the flow.

This may be done using an arrangement wherein the flow paths over opposing faces of a vane in use are of different lengths. In this way, an aerofoil effect is produced, so that there is a pressure difference between the opposing faces of the vane. The low pressure zone may be on either face of the vane (in contrast to an aircraft wing where lift is required).

Alternatively or additionally, this may be done using an arrangement wherein a constricted flow area is provided between two or more vanes. In this way, a venturi effect is produced, so that there is a low pressure zone in the constricted flow area. This can suitably be achieved using vanes of diamond-shaped cross-section.

The pitch of the vane is preferably chosen to provide a combination of high pressure difference and low drag. (This is analogous to the choice of angle of attack in an aircraft wing to provide a combination of high pressure lift and low drag.)

Preferably, the vanes present no substantial upper surfaces at less than 45° to the horizontal. This is because such surfaces may allow build-up of solid matter.

The pitch of the vane also affects the size of bubbles formed. Relatively large bubbles are desirable as they have a fast rise rate and are therefore better able to overcome the downward exit velocity. It is on the other hand undesirable for bubbles to be too large as they may disturb the white water cushion in the tank and the accumulating sludge on the water surface.

The pitch of the vanes is suitably selected taking the above considerations into account. This is preferably done during commissioning. As discussed below, the pitch may be fixed or adjustable. For vanes of fixed pitch, adjustments after commissioning may be required to take account of different operating conditions.

As an example, a vane of triangular cross-section is preferably arranged with the longest edge of the triangle facing upwards and horizontally downstream, and at an angle (pitch) in the range of 45° to 80°, more preferably in the range of 50° to 60° to the horizontal.

Typically the tank exit channel extends across the full width of the tank. Preferably, the tank exit channel is defined by the underflow baffle and a trough in the base of the tank. It is preferred for the longest edge of the triangle referred to above to be substantially parallel to an upstream side wall of the trough in the base of the tank. In one preferred embodiment, for example, both the longest edge of the triangle and the trough upstream side wall are at 53° to the horizontal.

Preferably, the vanes are provided across at least 50% of the width of the channel, and more preferably across substantially the full width of the tank exit channel (e.g. at least 90% of its width). An individual vane may extend across the full width of the tank exit channel, or vane sections may be provided which each extend part of the way across the tank exit channel as discussed in more detail below. The use of vane sections is particularly desirable on wide tanks, as it avoids excessive individual lengths being employed and therefore potential bowing of the vanes or the need to use a more substantial section.

A combination of vane sections positioned end-to-end so as to extend across the full width of the tank exit channel is referred to herein as a vane.

Suitably, 3 or more vanes are provided. 4 vanes is particularly preferred. The number of vanes should not be too high, as this may lead to undesirable head loss (pressure drop resulting from friction) across the tank exit channel with a consequent loss of energy. It is preferred that the head loss is less than 10 mm water gauge (wg) (about 100 Pa) and/or that a maximum of 50% of the tank exit channel area is occupied by vanes.

Preferably, the vanes are provided at an upstream part of the tank exit channel, and more preferably are positioned upstream of a part of the tank exit channel with minimum cross-sectional area. This is so that bubbles formed on or near the vanes will tend to be captured in the tank and not pass through the tank exit channel.

It is also preferable for a vertical line upwards from the uppermost vane, and more preferably from each vane, to pass upstream of the underflow exit baffle. Again, this is so that bubbles will tend to be captured in the tank.

More preferably, the vanes are provided between a lower surface of the underflow baffle and a trough in the base of the tank as mentioned above, for example between an upstream lower edge of the underflow baffle and an upstream lower edge of the trough. In a preferred embodiment, from uppermost to lowermost the vanes are progressively further upstream in the horizontal direction.

In some embodiments, some or all of the vanes are positioned on a notional planar or parabolic surface which extends from the lower wall of the underflow baffle to a base of the tank, preferably with the lower part of the surface upstream of the upper part of the surface in the horizontal direction. Arrangements wherein the lower vanes are positioned on such a plane or surface and the uppermost vane is upstream of the plane or surface have been found particularly effective. Computational fluid dynamics suggest that such arrangements provide lower head loss for the same tank exit channel minimum cross-sectional area.

In one preferred aspect of the invention, the vanes are fixed in position. Fixed vanes may be initially adjustable (for example during installation or commissioning). Preferably, all vane sections within a vane and/or all vanes are fixed at the same pitch. However, the vane sections and/or vanes may be fixed with different pitches.

In another preferred aspect of the invention, the vanes are movable such that they are adjustable in use, and more preferably they are rotatable about their principal axes (i.e. they have variable pitch). Movement of the vanes during the DAF process can be used to control the pressure drop at the tank outlet. This may be desirable as a replacement for alternative pressure controls. For example, at low flow rates, by varying the pitch of the vanes it would be possible to increase the head of pressure and thereby control the water and sludge level on the beach. This would provide an alternative to existing arrangements wherein the outlet weir is adjusted or the flow is forced through a common outlet pipe with a flow control valve.

Preferably, the moveable vanes can be remotely operated manually or automatically. This is suitably achieved by mechanically linking the vanes to a control means (for example in a similar manner to window blinds or louvers). Preferably all vane sections within a vane and/or all vanes are coupled such that they all have same pitch, but this is not necessarily the case.

As mentioned above, the vanes are suitably provided in the form of vane sections. In a preferred embodiment, vane arrangements each comprise a plurality of vane sections which co-operate to form a plurality of vanes. The vane arrangements can be placed end-to-end or otherwise combined to form the plurality of vanes. In a second aspect, the invention relates to such a vane arrangement.

Suitably, such a vane arrangement comprises a plurality of vane sections and a frame supporting the vane sections. The frame may suitably comprise side supports connected by upper and lower supports.

Preferably, the vane sections are initially rotatably mounted to the frame, for example by means of a peg/socket arrangement. The vane sections may be rotationally fixed to the frame, if desired, e.g. by means of a locking collar or pin, or may be linked as described above.

The components of the vane arrangement are suitably made from non-metallic corrosion-resistant material. Preferred materials include glass reinforced plastic (GRP) and stainless steel.

Preferably, the frame is moulded or fabricated from sheets.

Preferably, the vane sections are formed of glass reinforced plastics, which is suitably pultruded. Such sections are typically light, easy to handle and corrosion-resistant. This technique will ensure intrinsically light strong sections and minimise the amount of material required.

Any or all of the components shown in FIG. 1a and discussed above may also form part of the DAF apparatus. The pressure reduction nozzle of WO2011/042494 is particularly preferred.

The tank length L (upstream to downstream) and width W are preferably in the ratio L:W of 1:1 to 2:1, but width may be greater than length. Suitably the tank width is in the range of 5 to 20 m. A suitable tank width where mechanical scrapers are used to remove sludge from the surface is about 10 m. Where sludge is removed hydraulically tank widths of about 15 m are possible. Suitably, the tank depth is in the range of 3 to 6 m. Suitably, the height difference between the top wall of the inclined baffle and the lower wall of the underflow baffle is at least 0.75 m. The height of the inclined baffle is determined by the velocity of the water passing over it, and may for example be in the range of 1000 to 2000 mm, more preferably in the range of 1500 to 1750 mm.

In a third aspect, the invention relates to a method of manufacturing a dissolved gas flotation apparatus as described above, comprising positioning the flow-contacting members within the flotation tank exit channel.

Preferably, the method includes a step of forming an underflow baffle before the vanes are positioned. Suitably, the underflow baffle is formed by pouring of concrete using appropriate shuttering. A temporary block or hydraulic jacks can be used beneath the underflow baffle until the concrete has set and cured. The block or jacks can then be removed to form an open section in which the vane arrangements are positioned.

Preferably, the method includes a step of positioning vane arrangements as described above in a tank. Two or more vane arrangements are preferably arranged end-to-end so that the combined vane sections form vanes. Alternatively, a single vane arrangement can extend across the tank, or the vanes can be provided mounted directly to the tank without a frame.

Where the vanes are fixed, the method suitably includes a step of fixing the vanes in position, for example by means of the locking collars or pins referred to above. This step may be carried out during installation or commissioning.

In a fourth aspect, the invention relates to a dissolved gas flotation process using the dissolved gas flotation apparatus described above, comprising:
supplying a feed stream to the flotation tank;
supplying a gas-saturated stream to the flotation tank via the pressure reduction nozzle(s); and
withdrawing an effluent stream from the flotation tank via the flotation tank exit channel.

Preferably, the vanes contribute to bubble formation, bubble capture and/or bubble coalescence.

Preferably, the vanes provide pressure differences in the flow.

Preferably, at least one vane is so arranged that when the vane contacts the effluent stream opposing faces of the vane provide flow paths of different lengths and/or the effluent stream passes through a constricted area, as discussed in more detail above.

Preferably, when adjustable vanes are used, the process further comprises a step of adjusting the vanes, typically by changing their pitch. Again, this is discussed in more detail above. The process preferably also comprises a step of monitoring at least one process parameter (for example water level or flow) and determining based on this whether adjustment of the vanes is necessary.

The flow per cell may for example be in the range of 1000 to 3000 m³/h. This is dependent on the desired retention time in the flocculation tank. Preferably, the recycle flow rate is in the range of 5 to 25%, more preferably in the range of 6 to 16%. A minimum recycle flow rate is required to maintain stability. A maximum recycle flow rate is set by cost and process efficiency considerations. This maximum is dependent on air dose rates, which are typically in the range of 6 to 10 g air/m³. For example, in high temperature seawater applications the inventors have aimed for 9 g air/m³ which sets an upper flow rate of 15-16%. Saline water generally requires higher recycle flow rates than non-saline water.

Preferably, the temperature of the feed stream is in the range of 10 to 40° C.

The dissolved gas flotation process may be carried out on salt water or on non-saline water e.g. surface water.

In a fifth aspect, the invention relates to a salt water desalination process comprising an initial dissolved gas flotation process as described above. The process may include a distillation step, e.g a multi stage flash (MSF) step.

In further aspects, the invention relates to a dissolved gas flotation apparatus, a method or a process substantially as herein described with reference to the description and/or drawings.

All features described in connection with any aspect of the invention can be used with any other aspect of the invention. In particular, features described in connection with vanes above are typically also applicable to flow-contacting members in general.

The invention will be further described with reference to preferred embodiments and to the drawings in which:

FIG. 1a is a schematic diagram of a known DAF apparatus.

FIG. 1b is a schematic diagram of the flotation tank of the apparatus of FIG. 1a.

FIG. 2 is a schematic diagram of the flotation tank of FIG. 1b, showing typical recirculation modes during efficient operation.

FIG. 3 is a schematic diagram of the flotation tank of FIG. 1b during operation at a flow rate exceeding the tank design, showing the underside of the white water cushion leaving the tank.

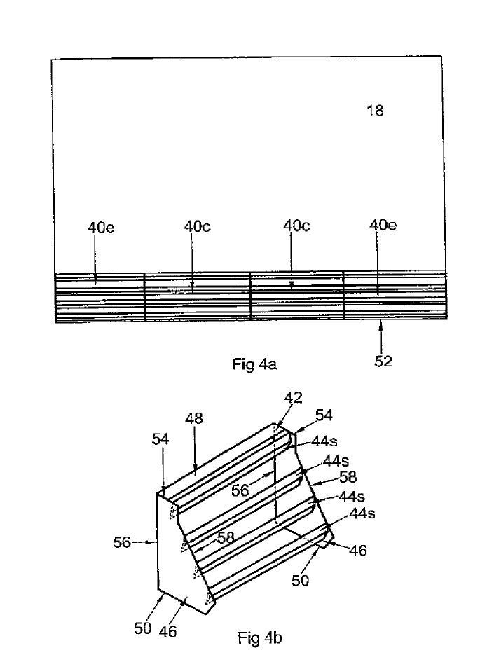

FIG. 4a is a view from upstream of the tank exit channel of a DAF tank of a first preferred embodiment of the invention showing box sections consisting of wing sections and frames. FIG. 4b is a perspective view of a box section of FIG. 4a.

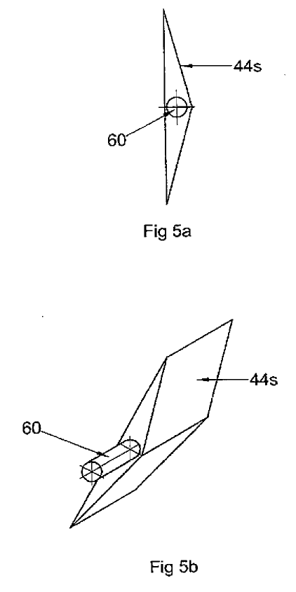

FIG. 5a is a cross-section through a triangular cross-section wing section as shown in FIG. 4. FIG. 5b is a perspective view of the wing section of FIG. 5a.

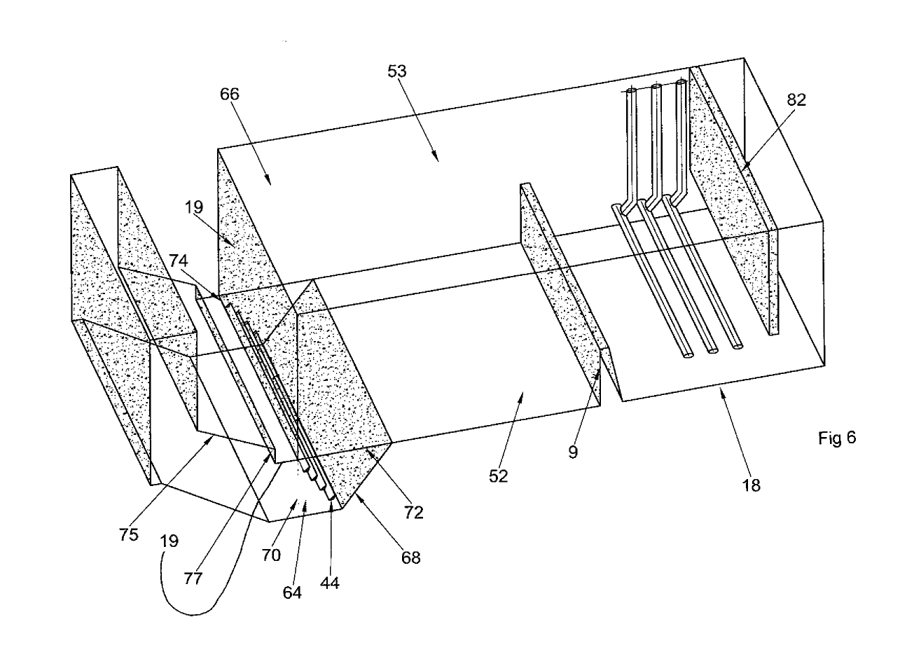

FIG. 6 is a cutaway perspective view of a DAF tank of the Examples (models B, B1 and B2). The tank has a modified underflow baffle compared with that of FIG. 1b.

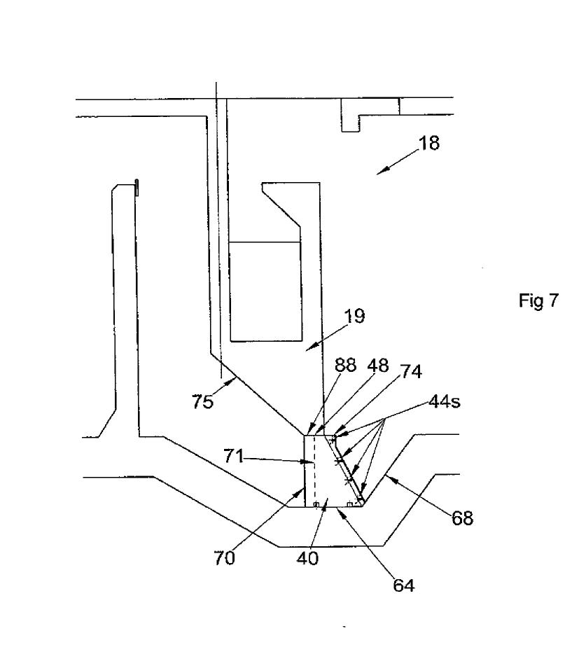

FIG. 7 is a cross-sectional view of the downstream part of the DAF tank of FIG. 4a showing an embodiment with fixed wings.

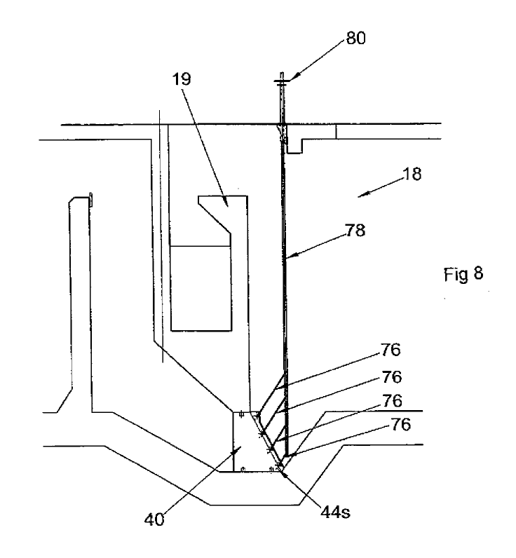

FIG. 8 is a cross-sectional view of the downstream part of the DAF tank of FIG. 4a showing a modified embodiment with moveable wings.

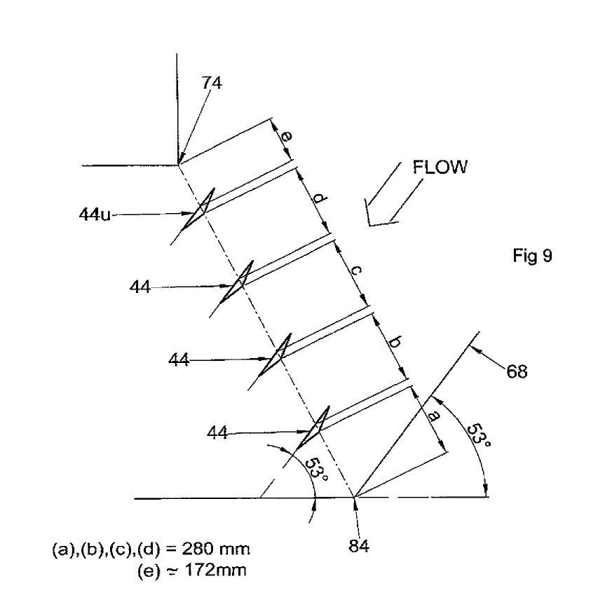

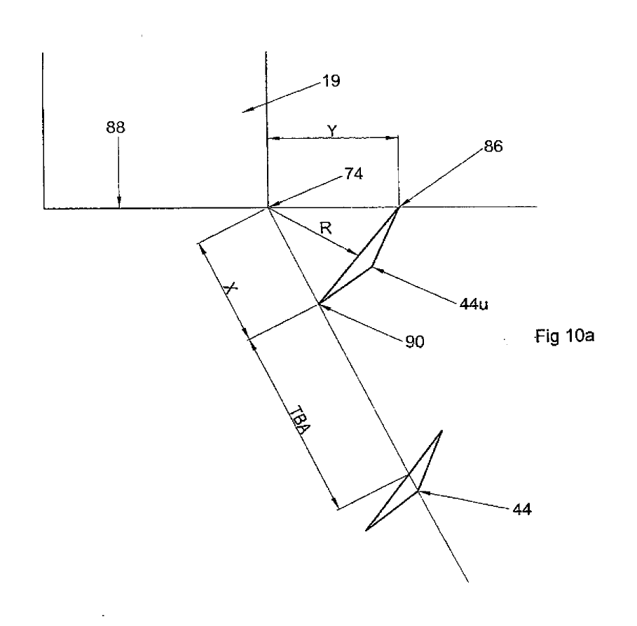

FIG. 9 is a schematic diagram showing the wing positioning in model B1 (Examples).

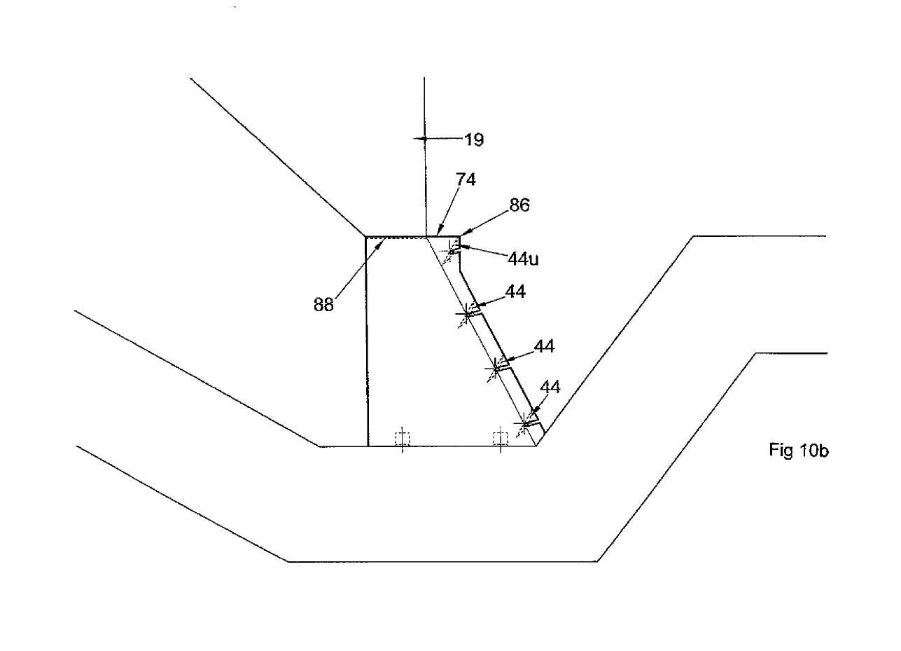

FIG. 10a is a schematic diagram showing the upper wing positioning in model B2 (Examples). FIG. 10b is a cross-sectional view of the wing arrangement in model B2, being also an enlarged view of the wing arrangement of FIG. 7.

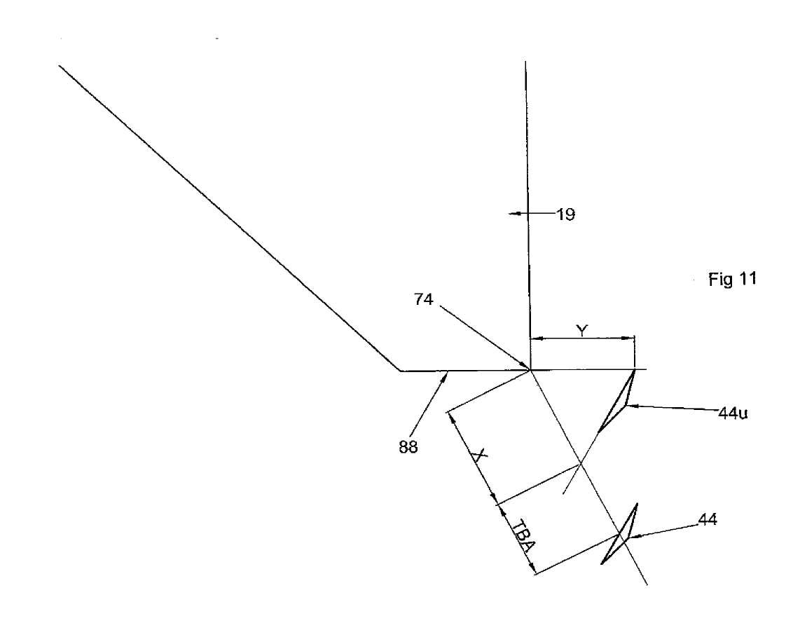

FIG. 11 is a schematic diagram showing the upper wing positioning in model C1 (Examples).

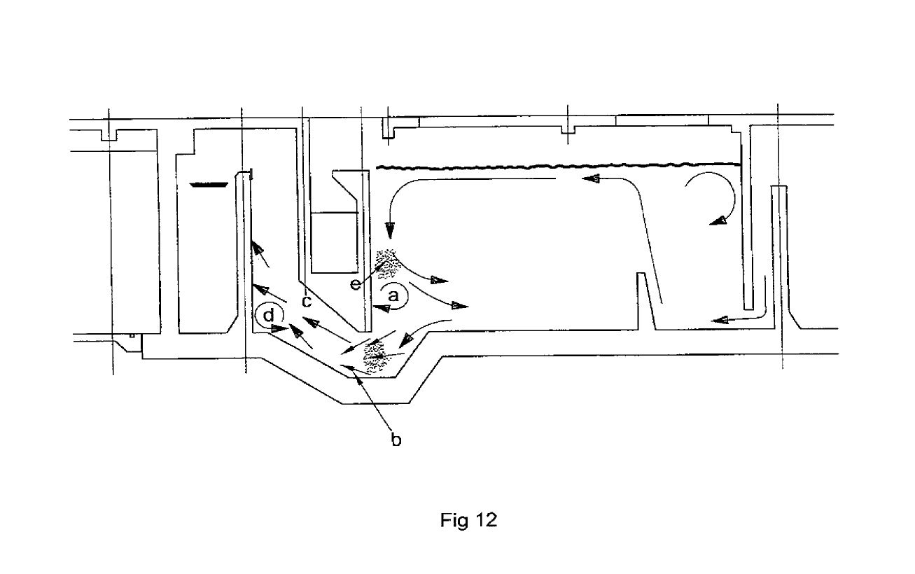

FIG. 12 is a schematic diagram of a DAF tank according to model C1 (Examples), showing flow paths during operation.

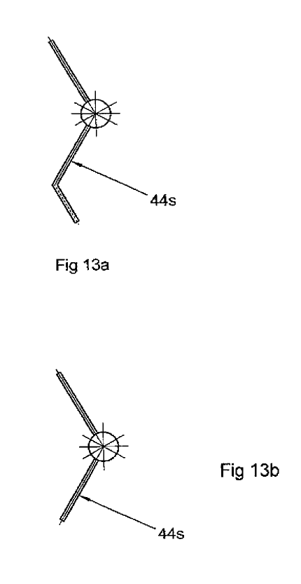

FIGS. 13a and 13b are cross-sections through alternative wing section designs: FIG. 13a shows a Z cross-section wing and FIG. 13b shows a V cross-section wing.

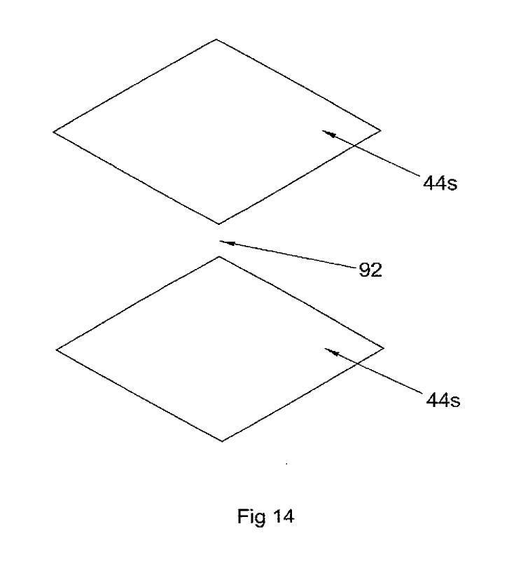

FIG. 14 is a cross-section showing the wing positioning in an alternative design. Two diamond cross-section wings are shown.

### TANK CONSTRUCTION

### Fixed Wing Arrangement

As shown in FIG. 4a, the wings (also called vanes; these are examples of flow-contacting members) are formed in four separate box sections (also called vane arrangements) 40 to be positioned end-to-end across the full width of the DAF (dissolved gas flotation) tank 18. There are two end sections 40e and two central sections 40c.

Each section consists of a frame 42 and four wing sections 44s (FIG. 4b).

The frame 42 is integrally formed of glass-reinforced plastics. The frame consists of two mirror-image support walls 46 connected by an upper rectangular support 48 and a lower rectangular support (not shown) such that they are parallel and in register. The support walls 46 are laminar and in shape correspond approximately to a right-angled triangle with the two points cut off. Each support wall 46 has a lower edge 50 meeting the lower support (which is to be positioned on the base 52 of the DAF tank 18 and is horizontal in use), an upper edge 54 meeting the upper support 48 (horizontal in use), a back edge 56 at right angles to the lower edge 50 (vertical in use), and a sloped leading edge 58. Each support wall 46 has 4 spaced sockets (not shown) on its inner face along the leading edge 58 for connection with the wing sections 44s, to form 4 pairs of aligned sockets. The position of the sockets determines the position of the wing sections 44s within the DAF tank 18 in use.

Each wing section 44s is a rod-like cylinder (“cylinder” taking the meaning set out above) of length 2.5 m with constant triangular transverse cross-section (FIG. 5a). The precise shape of the wing cross-section is discussed in more detail below (Examples). Each end of the wing section 44s has a short cylindrical peg 60 extending from its centre for connection to the support walls 46 (FIG. 5b). The wing sections 44s are formed from pultruded sections of glass-reinforced plastics.

In each box section 40, the four wing sections 44s are mounted to the frame 42 by co-operation of each peg 60 with a corresponding socket on the support walls. Thus, the wing sections 44s extend across the frame 42 parallel to one another and to the upper 48 and lower supports (so that they are horizontal in use). The peg/socket connections allow adjustment during commissioning.

The DAF tank 18 of this preferred embodiment (FIG. 7) is similar to that of FIG. 1b described in detail above, except for the presence of the box sections 40.

The DAF tank 18 is formed as follows. Concrete is poured to form the DAF tank base 52, walls 53, inclined baffle 9, underflow baffle 19 (as described in more detail below), and inlet baffle 82.

To form the underflow baffle 19, reinforcing steel work (not shown) is provided to tie the underflow baffle 19 to the walls 53 of the DAF tank 18. Appropriate shuttering (not shown) is provided, including a block used to form an open section (not shown) above the trough 64. The concrete is poured to form the underflow baffle 19 which extends across the width of the DAF tank 18. The underflow baffle has a downstream wall 75 with a lower sloping section and an upper vertical section. The shuttering and block are removed once the concrete has set and cured.

The resulting DAF tank 18 has a tank exit channel 70 between the underflow baffle 19 and the trough 64 in the base 52 of the DAF tank 18 as described in connection with FIG. 1b above. The tank exit channel 70 has a part 71 of minimum cross-sectional area below the lower wall 88 of the underflow baffle 19.

Four box sections 40 are assembled as outlined above. The box sections 40 are positioned within the tank exit channel 70 (FIG. 7). The box sections 40 are positioned end-to-end with support walls 46 aligned and abutting, such that the sections together extend across the full width of the DAF tank 18. As a result, wings 44 (each formed from 4 wing sections 44s) extend across the full width of the tank 18 at the upstream part 72 of the tank exit channel 70.

The box sections 40 are secured by bolting and grouting to the concrete structure of the DAF tank 18.

During commissioning, the plug/socket connections between the wing sections 44 and frames 42 of the box sections 40 are secured using locking pins (not shown) to maintain each wing section 44s at the same fixed pitch.

A modified embodiment of the DAF tank is shown in FIG. 6. This is very similar to the embodiment of FIG. 7, except that the downstream wall 75 of the underflow baffle 19 has a lower vertical section 77 beneath the sloping section.

### Moveable Wing Arrangement

This embodiment (FIG. 8) is similar to the fixed wing arrangement described above. However, the angle of the wings 44 can be adjusted remotely during use of the DAF tank.

To achieve this, the pegs 60 of each of the wing sections 44s are mechanically linked via struts 76 to a rod 78 which extends from the top of the DAF tank 18. The upper end of the rod is provided with an actuated wheel 80 which can be rotated to adjust the pitch of each of the wing sections 44s, maintaining the same pitch for each wing section (in a similar way to window blinds or louvers).

### Alternative Wing Designs

Alternative wing section 44s cross-sections are shown in FIG. 13. In these, the wing sections 44s take the form of shaped plates rather than triangular cross-section cylinders. In FIG. 13a, the wing cross-section is Z-shaped with internal angles of 120° (plate widths 117 mm, 117 mm, 58 mm). In FIG. 13b, the wing cross-section is V-shaped, also with an internal angle of 120° (plate widths 117 mm, 117 mm; overall wing width 200 mm).

A further alternative wing section 44s cross-section is shown in FIG. 14. The wing sections 44s each take the form of a diamond cross-section cylinder. A constricted area 92 is formed between the adjacent edges of the two wing sections 44s.

### Operation of DAF Process

The DAF tanks of the preferred embodiments are operated generally as described in connection with FIG. 1a above.

For the DAF tank with moveable wings, the wings 44 are adjusted during operation via the wheel 80. The flow and water level in the DAF tank are monitored to determine appropriate adjustments.

### EXAMPLES

CFD modelling was used to test the performance of various DAF tanks in accordance with preferred embodiments of the invention. The model was based on a seawater treatment plant at Ras Al Khair, Saudi Arabia.

CFD modelling applies the fundamental equations of fluid dynamics from first principles. Solving for conservation of mass, momentum, turbulent kinetic energy and eddy dissipation across a three-dimensional mesh, a numerical solution which accurately depicts the hydraulic structure is created using Navier-Stokes' equations (Versteeg and Malalasekera, 1995; Marshall and Bakker, 2001). The model has been developed over a number of years, and compared with experimental measurements, for example of the position of the lower front of the white water cushion.

Vorticity is a measure of the predicted turbulence and local eddy recirculation within the flotation plant. The vorticity within a computational fluid dynamics (CFD) model of the DAF phase of a pre-treatment plant has been shown (Amato and Wicks, 2007 and 2009-2) to be directly correlated with the turbidity of the effluent water. A lower vorticity magnitude corresponds to clarified water with low turbidity. Typical vorticities which provide good quality clarified water are less than 0.20 s⁻¹.

The CFD model used was a dynamic (time varying), multiphase (water/air), Eulerian-Eulerian, k-ε RNG turbulence model. The software used was ANSYS Fluent 13.0.

In the CFD models, the DAF flotation tank cells (FIG. 6) are 10.1 m in length from inlet baffle 82 (right, upstream) to outlet underflow baffle 19 (left, downstream), 5.83 m high from base 52 to upper coping level, and 10.1 m in width. The inclined baffle 9 is 1,650 mm high and at an angle of 81° to the base of the tank as shown in FIG. 6. The trough 64 beneath the underflow baffle 19 has its upstream sloping wall 68 at an angle of 53° to the horizontal. For models B, B1 and B2 the downstream wall of the underflow baffle is as in FIG. 6, and for model C1 this wall is as in FIG. 7.

Raw water and recycled water enter via the inlet baffle 82 and dissolved air enters through diffusers 28 between the inlet baffle 82 and inclined baffle 9.

Model B (without wings) is used as a control.

Models B1, B2 and C1 (with wings) form part of the invention.

The location of wings is altered between each model, as described in more detail below, but the design of each wing is the same. Each wing is a rod-like cylinder with constant triangular cross-section as discussed under “Tank Construction” above (FIG. 5a). Specifically, the cross-section is an isosceles triangle of base 200 mm, base angle 15°, height 27 mm and sloping sides 104 mm. In each case 4 wings 44 are used, and the wings 44 extend across the full width of the DAF tank 18. The wings are not divided into sections.

The pitch of the wings 44 is also the same for each model. The wings 44 are each arranged with the triangle base uppermost and parallel to the trough wall 68 i.e. at 53° to the horizontal.

In model B1 (FIG. 9) the wings 44 are arranged horizontally on a notional diagonal plane from the upstream lower edge 74 of the underflow baffle 19 to the upstream lower edge 84 of the trough 64 in the base 52 of the tank 18. Starting from edge 84 of the trough, the wings 44 are positioned at intervals of about 280 mm. The uppermost wing 44u is about 172 mm from the underflow baffle 19.

In model B2 (FIGS. 10a and 10b) the three lower wings 44 are arranged as in model B1. The uppermost wing 44u is located with its upper edge 86 horizontally level with the lower surface 88 of the underflow baffle 19. Its upper edge 86 is 187.0 mm (Y) upstream of the underflow baffle 19 in the horizontal direction. The centre of its base is 119.1 mm (R) from the upstream lower edge 74 of the underflow baffle 19. Its lower edge 90 is 193.8 mm (X) from the upstream lower edge of the underflow baffle 74, and 268.1 mm (TBA) from the next wing 44.

In model C1 (FIG. 11) the wings 44 are arranged generally as in model B2 but with Y=250 mm, X=259.1 mm, R=216.5 mm, TBA=268.1 mm.

Each model is constructed from approximately three million tetrahedral cells converted into polyhedra.

The seawater properties are modelled based on the following analysis (Table 1), assuming the worst case. The worst case when considering how much air can be dissolved is maximum temperature and salinity, leading to less dissolved air. The worst case when considering the white water level is generally minimum temperature and maximum flow or hydraulic loading rate, leading to a lower white water level.) The minimum temperature is 22° C. because in this plant cooling water is returned from the multi stage flash (MSF) distillation area used for desalination, thereby maintaining a feed temperature above the natural minimum of 14° C.

TABLE 1

Seawater Analysis
Applicable To All Flows

| | | Min | Max |
|---|---|---|---|
| pH | | 8 | 8.3 |
| Temperature | ° C. | 22 | 38 |
| Conductivity @ 25° C. | μS | 59,000 | 64,000 |
| TDS @ 180° C. | mg/l | 38,000 | 47,000 |
| TSS | mg/l | 20 | 40 |
| | | | (Red Tide) |
| Sodium (Na) | mg/l | 12,500 | 13,500 |
| Chloride (Cl) | mg/l | 22,200 | 24,800 |
| Fluoride (F) | mg/l | 1 | 1.2 |
| Total Hardness (as CaCO₃) | mg/l | 7,000 | 8,000 |
| Sulphate (SO₄) | mg/l | 3,100 | 3,400 |
| Alkalinity (as CaCO₃) | mg/l | 120 | 130 |
| Iron (as Fe) | mg/l | 0.01 | 0.10 |
| Boron (as B) | mg/l | 4.5 | 5.5 |

TDS = total dissolved solids

TSS=total suspended solids

Results for models B (comparative), B1, B2 and C1 (forming part of the invention) are shown in Table 2, indicating the effect of the wing arrangements on white water level and vorticity. In each case the flow/cell was 3,008 m³/hr, recycle rate flow was 601.6 m³/hr (20%) and temperature was 14° C.

TABLE 2

| Model | WWL (m above base) | Vorticity (s⁻¹) |
|---|---|---|
| B1 | 0.453 | 0.089 |
| B2 | 0.449 | 0.089 |
| C1 | 0.454 | 0.089 |
| For comparison: | 0.477 | 0.090 |
| model B (no wings) | | |

It can be seen that the presence of the wings near the outlets had generally little effect on the bulk white water level or vorticity magnitude.

Based on the previous studies of vorticity mentioned above, it is believed that the wings will not have a detrimental impact on the overall water quality leaving the tank, since vorticity is less than 0.20 s⁻¹. White water level is acceptably high.

A summary of the CFD model results is shown in FIG. 12 (the tank design is that of C1, but results for B2 are similar). This can be contrasted with FIGS. 2 and 3.

The results of design options B2 and C1 were promising. Velocities in B1 were considered from a review of plotted velocity vectors to be higher than desirable. Whilst turbulence is desirable as explained below, excessive velocity in the region of the underflow baffle is undesirable because it leads to head loss across the outlet with a consequent loss of energy. It is believed that positioning the uppermost wing upstream as in models B2 and C1 helps to reduce velocity and minimise head loss.

Without wishing to be bound by this theory, the inventors believe that the model DAF tank operates as follows.

The primary function of the wings is to capture bubbles onto their surface and to coalesce bubbles, thus reducing the appearance of white water downstream of the underflow baffle.

The wings change the flow path and create streaming, acting as aerofoils or fins.

Additional rotational flow occurs upstream of the wings at (a). This recirculation delays escape of water from the DAF tank.

Immediately downstream of the wings, there is a region (b) of low velocity but high turbulence as flows collide. This turbulence will encourage release of air and bubble coalescence.

The result will be bubbles that are larger and therefore have a faster rise rate and are better able to overcome the downward exit velocity, as shown at (e). This action is expected to mitigate the escape of air and particulate matter from the DAF cell. Bubbles which are too large can be avoided by appropriate selection of the wing pitch as discussed above.

Further additional rotational flow occurs downstream of the wings at (d). This recirculation forms a low pressure region, further encouraging air release and bubble coalescence. Recirculation at (d) also occurs where no wings are present, but CFD indicates that this mode is not so pronounced. There is a high velocity region downstream of the baffle at (c).

Thus, where air does exit the DAF tank, it continues to coalesce in the high and low velocity regions (c) and (d). The bubbles formed in this way will be larger than those normally exiting the cell. As discussed above, such bubbles are less likely to interfere with in-line turbidity measurements, so that the need for offsite measurements is likely to be reduced.

Thus, the preferred embodiments of the invention tested in the CFD models have a number of advantages:
The presence of air and suspended matter downstream of the DAF tank is reduced, meaning that water quality is higher;
Where air does exit the DAF tank, it forms larger bubbles which are less likely to interfere with turbidity measurements;
Good results can be achieved in saline water, at low water temperatures and at high flow rates;
Recycle flow rates can be relatively low (subject to the minimum recycle flow rate required for stability);
The tank can be relatively shallow; and
The tank design is simple with access to all points for maintenance.

In these embodiments, therefore, the wings allow higher hydraulic loads to be applied to a shallower tank than would otherwise be the case.

Although the invention has been described with reference to the illustrated preferred embodiments, it will be recognised that various modifications are possible within the scope of the invention.

### REFERENCES

Amato, T. & Wicks, J. (2007) The Practical Application of Computational Fluid Dynamics To Dissolved Air Flotation Plant Operation, Design and Development, pp. 105-112, 5^{th} International Conference on Flotation in Water and Wastewater Systems, Seoul, South Korea.
Amato, T. & Wicks, J. (2009—1) The Practical Application of Computational Fluid Dynamics To Dissolved Air Flotation Plant Operation, Design and Development, Journal of Water Supply: Research and Technology—AQUA 58.1 2009 pp. 65-73
Amato, T. and Wicks, J. (2009—2) Dissolved Air Flotation And Potentially Clarified Water Quality Based on Computational Fluid Dynamics Modelling, American Water Works Associating WQTC Conference Proceedings.
Marshall, E. M. & Bakker, A. (2002) ‘Computational Fluid Mixing’, Fluent Inc., Lebanon (USA)
Versteeg, H. K. & Malalasekera, W. (1995) ‘An Introduction to Computational Fluid Dynamics: The Finite Volume Method’, Longman Scientific & Technical, Essex (UK)
Wicks, J. D. (2010) WWTmod2010 Workshop ‘Understanding CFD Modelling of WWTP: Successful Applications, Limitations and Future Directions’, Mont-Sainte-Anne, Quebec (Canada)

1. A dissolved gas flotation apparatus comprising:
a flotation tank;
one or more pressure reduction nozzles arranged to discharge into the flotation tank;
an underflow exit baffle defining an upper part of an exit channel from the flotation tank; and
a plurality of flow-contacting members which introduce a pressure difference in a flow, the flow-contacting members being arranged within the flotation tank exit channel:
such that flow paths over opposing faces of a flow-contacting member in use are of different lengths so that an aerofoil effect is produced creating a pressure difference between opposing faces of the flow-contacting member; and/or
such that a constricted flow area is provided between two or more flow-contacting members so that in use a venturi effect is produced creating a low pressure zone within the constricted flow area.

2. An apparatus as claimed in claim 1, wherein the flow-contacting members include one or more of:
vanes;
bubble-forming members;
bubble-capturing members;
bubble-coalescing members;
turbulence-introducing members;
flow-redirecting members;
pressure-increasing or pressure-decreasing members; and
velocity-increasing or velocity-decreasing members.

3. A dissolved gas flotation apparatus as claimed in claim 1, wherein at least one flow-contacting member is a vane having an edge with an angle of 90° or less in transverse cross-section.

4. A dissolved gas flotation apparatus as claimed in claim 3, wherein at least one flow-contacting member is a vane of triangular, quadrilateral or star-shaped transverse cross-section.

5. A dissolved gas flotation apparatus as claimed in claim 1, wherein the flotation tank exit channel has a part of minimum cross-sectional area, and the flow-contacting members are positioned upstream of the part of the flotation tank exit channel with minimum cross-sectional area.

6. A dissolved gas flotation apparatus as claimed in claim 1, wherein an uppermost flow-contacting member is horizontally upstream of the underflow exit baffle.

7. A dissolved gas flotation apparatus as claimed in claim 1, wherein the flow-contacting members are fixed in position.

8. A dissolved gas flotation apparatus as claimed in claim 1, wherein the flow-contacting members are adjustable.

9. A dissolved gas flotation apparatus as claimed in claim 1, wherein the flow-contacting members are provided by vane arrangements each comprising a plurality of vane sections which co-operate to form a plurality of vanes.

10. A method of manufacturing a dissolved gas flotation apparatus as claimed in claim 1, comprising positioning the flow-contacting members within the flotation tank exit channel.

11. A dissolved gas flotation process using the dissolved gas flotation apparatus of claim 1, comprising:
supplying a feed stream to the flotation tank;
supplying a gas-saturated stream to the flotation tank via the pressure reduction nozzle(s); and
withdrawing an effluent stream from the flotation tank via the flotation tank exit channel.

12. A process as claimed in claim 11, wherein at least one flow-contacting member is so arranged that when the flow-contacting member contacts the effluent stream opposing faces of the flow-contacting member provide flow paths of different lengths and thereby introduce a pressure difference in the effluent stream between the opposing faces of the flow-contacting member.

13. A process as claimed in claim 11, wherein two or more flow-contacting members are arranged to define a constricted flow area for the effluent stream between the flow-contacting members and thereby produce a low pressure zone in the effluent stream within the constricted flow area.

14. A process as claimed in claim 11, wherein the flow-contacting members are adjustable, further comprising a step of adjusting the flow-contacting members.

15. A salt water desalination process comprising an initial dissolved gas flotation process as claimed in claim 11.
